(19) United States
(12) Patent Application Publication
(10) Pub. No.: US 2012/0084127 A1
(43) Pub. Date: Apr. 5, 2012

(54) TRANSACTION SYSTEM AND METHOD FOR DISTRIBUTING PROFIT-SHARING INCENTIVES WITHIN SOCIAL MEDIA NETWORKS AND ONLINE COMMUNITIES

(76) Inventor: Nk Nkrumah, Ottawa (CA)

(21) Appl. No.: 12/898,041

(22) Filed: Oct. 5, 2010

(51) Int. Cl. G06Q 30/00

(52) U.S. Cl. 705/14.15

(57) ABSTRACT

A system and method for conducting revenue-generating transactions by creation and dissemination of a pooled profit-sharing incentive among users of a social network or other online community.

### FIELD OF THE INVENTION

The present invention concerns methods for conducting transactions via the internet by subscribed members of a social media network, in which the subscribed members form a business entity from which incentive benefits are distributed periodically to members. More particularly, the invention relates to a system for rewarding subscribers who are members of the business entity by providing such members with opportunities to win a pooled share of the revenues gained from transactions conducted via the social media network.

### BACKGROUND OF THE INVENTION

The advent of social networking based on the common interests and interactions between members of online communities is a relatively new development; however it has changed the face of the internet and the way in which it is used. The social network connects people across the globe and provides a platform for people to interact, express and promote themselves and their interests in ways that have never before been imagined. Online communities evolved out of the idea of bringing people together to share information, exchange views and ideas via a personalized and/or customizable homepage that allows users to create individual profiles. Using these profiles, users can send messages each other, keep lists of contacts popularly referred to as friends, post audio, video, picture and other files as well as links to other internet sites. Users can also search for and identify other users based on similar characteristics and interests.

Connecting with like-minded people and creating new relationships are some benefits of online communities, but also among these benefits are the consumption and use of various goods, information and services. One example of these is digital media, which as defined herein includes for example music, audio, video, games, e-books, and other electronic file based applications and records. Social networking has redefined the boundaries for digital media, which nowadays plays an important role in the success of social networking communities by providing users the ability to upload, download or otherwise share songs and other audio files; as well as to similarly share and also watch video and play games. These peer-to-peer and other networking activities based on a defined social network thus stimulate activity at the individual level of the user; however they also open new opportunities for manufacturers, marketers and business strategists. The social network serves as a great promotional tool for content creators and advertisers alike.

Because of the potential size of these online communities, social networking has been particularly advantageous to artists like musicians and performers. This is because an online community, which provides a common venue for persons with shared interests, allows access to wider fan bases and has the ability to provide greater exposure. This invention therefore provides a new method and business model that allows sellers of digital media content, such as artists, to potentially increase sales while simultaneously benefiting consumers and incentivizing participation in the online community. This creates a win-win scenario for all involved; including but not limited to users or consumers, fans, artists (musicians, performers, content creators), as well as labels, promoters, retailers, webmasters, site owners, advertisers, entrepreneurs, and enterprise content creators.

Another issue that has been identified is that social networks have been difficult to monetize, i.e. to become generators of revenue, beyond the basic advertising model, in which advertisements are posted to raise consumer awareness and invite participation. This model does not provide an incentive to the online consumer beyond offering the prospect of making a purchase. Subscription models in which websites invite subscribers and make content available to those subscribers, optionally for a fee, while excluding some or all content from nonsubscribers, are known as well. However, users have been reluctant to pay for this type of online community participation unless there is a definite promise of increased value, such as unique content or an added service benefit. To compound the relative lack of success in making conventional online community models profitable as means of conducting business transactions, online communities have heavy back end maintenance requirements, use high bandwidth and, depending on the size of the network, can cause heavy server loads. These factors can make it costly and difficult to become profitable using only an advertising model. This invention attempts to advance the changing monetization trends by providing a new method for conducting profitable transactions in a way that is mutually advantageous.

Several needs are met by the various embodiments of this invention, as exemplified below.

In some embodiments, this invention provides a means to help artists, performers, manufacturers, merchants and other develop additional potential for revenue while they are offering transactions in the social media marketplace, in ways that harness the capacity and influence of such networks. Another need satisfied by particular embodiments of the invention is to help artists make money to fund their careers. Due to the significant expenses involved in producing and releasing creative works, artists often have a hard time making ends meet while pursuing their careers. Particularly for musicians, funding activities such as promotional events and materials, travel expenses, studio time, and videos becomes an overwhelming obstacle and many talented artists are unable to bring their projects to completion and release them into the marketplace because of the expenses involved.

Embodiments of the invention also provide a way for users to be able to benefit monetarily from an internet site that they help make successful. In this respect, even if the user is not a content creator, the user still plays an important role in the success of the online community, and all the users' continued participation is key to appreciating the perceived value of the social network. The models provided by the embodiments of this invention recognize and reward the users' contributions.

Additionally, in the realm of equal opportunity capitalism in today's world, trends are arguably towards a more horizontal as opposed to vertical business models of capitalism. The internet, technological innovations and new business models have begun to level the playing field and are proving that virtually all enterprises can contribute and compete in the market place, whether they are big or small according to traditional characterizations.

Piracy, or the unauthorized use of intellectual property contained in digital media, continues to be an issue for content creators and copyright holders. The result has been that sponsors, record labels and other would-be investors nowadays scale back the amount of money they are willing to invest in new creative projects. This growing problem of piracy makes it harder to sell authorized digital products, as many online users can unlawfully obtain them quite freely and with minimal effort using the Internet.

The Internets ease of distribution and the ubiquitous access to free content makes consuming pirated digital media a hard proposition for users to resist. Since the advent of the web, the losses content creators and copyright holders incur annually have grown every year and are projected to continue. Defensive technology to combat piracy is often circumvented and the expectation that mass prosecutions, which are often unfeasible due to costs, will serve as a deterrent to would-be pirates is not particularly effective, since individual defendants can rarely afford to pay compensation penalties, and the costs of this type of enforcement are extremely high in comparison to any return, the biggest value being a temporary deterrence, which can often be quickly circumvented. Without effective strategies to combat digital piracy, artists and the media industry are losing out on potential sales and since steps to quash the practice of piracy have so far been ineffective, a new strategy is required. The method of this invention incorporates incentives to encourage legal consumption of digital media by extending the profit motive, traditionally held only by content creators and copyright holders, to users as well.

Incentives have always been a better means of achieving compliance, rather than through force or deterrence. As mentioned previously, deterrents used to date have failed, technology is routinely circumvented, and burgeoning artists lose potential sales, therefore it is at least clear that a different approach needs to be taken. Downloading digital media for free through the Internet is so easy that solving this problem will necessarily harness the typical user's motivations by giving the user greater reason not to want to engage in piracy. This is accomplished by providing to users the prospect of gaining some type of reward if they make downloads or engage in other transactions online legally. The key is to establish a win-win situation whereby the users and the content creators (often times playing dual roles as both user and creator) are encouraged and rewarded for participating. In particular, monetary incentives are proven to work as an effective way of motivating behavior, because they appeal to the human motivation to know “What's in it for me?” The model provided by the current invention uses a profit sharing structure to give everyone involved an opportunity to share in the success of the online community as an added benefit to their purchase or other transaction. In this way, users become engaged and assume a type of ownership responsibility for the success and effectiveness of the social network, They are more involved in the building of the community, in its economic well-being, and they feel personally invested in the community and have an interest in seeing it thrive. In the digital media transactions application of the invention, for example, both the artists and sellers of digital content, as well as buyers and users, can potentially benefit. The benefits experienced, by artists for example, will be to possibly use their share to build their careers and fund projects, and for consumers, they can potentially use their share for any personal benefit. In this way the method of the invention will reinvigorate the digital media industry by increasing sales, and this in turn would increase the overall quality of content, and as a result users would receive the higher value benefit of the items being consumed.

Traditionally businesses and consumers have acted as distinct agents, however social networks have made it so users can also be content creators, thereby blurring the role between consumer and supplier. The advertising, subscriptions and sometimes broker models, in their various forms, have been the favored means to take advantage of this shift. However, social networking is still a relatively young phenomenon and trends are constantly changing, moreover these earlier transaction models don't address key issue that will need to be solved to meet the challenges of this evolving landscape; those issues being the aforementioned problem of piracy and monetization. Advertising models are based on accumulating large amounts of Internet traffic and then selling this traffic value to advertisers seeking to reach a large audience for their goods or services. Subscription models charge fees to users for access to the site, however this model does not work well with the advertising model as the goal is to have large user base, and charging a fee for membership often turns users away. Broker models usually bring buyers and sellers of content together, with the broker taking a commission on the sale. This method can be incorporated into social networks but is rarely a stand-alone method; it is usually applied to market-maker websites. This invention uses the best of all these models but differs in a novel way, in that it adds a profit sharing element. This profit-sharing element is structured into a business model using a method that is unprecedented for online social networks. Profit sharing structures themselves are nothing new; they have existed for a long time and are in use by many companies around the world, though not in any application that would teach or suggest the various embodiments of the current invention. Profit-sharing is an excellent incentive tool because it invokes a feeling of fairness among the people involved in a particular cause or endeavor; this cause being the success of the online community. Therefore, although profit sharing of itself is not a revolutionary idea, social networking sites have yet to make use of this method, as it has until now been unclear as to exactly how such a feature would be implemented. The closest approach to shared profits is a share structure between site owners and content suppliers, however there has previously been no means to extend profit-sharing to content consumers. In fact, at first glance this would seem counter intuitive to persons unfamiliar with this invention to engage in profit-sharing with consumers because this would be the same as subsidizing or lowering the price of the item being consumed, which is not a desirable action in the digital competitive environment. This method overcomes those issues and establishes a new invention and a patentable business method not previously addressed by the prior art.

U.S. Pat. No. 6,872,138 describes a system for tracking proceeds from a game of chance in which, in a computer environment, registered player accounts such as education or medical savings accounts are set up for players; and a predetermined portion of the player's purchase is set aside, in which the amount set aside is based on the amount of the registered player's purchase. The purchase is of a game of chance, for example a lottery. Accordingly, this system tracks the proceeds of the game of chance, determines player accounts according to the amount of an individual player's purchase, and rewards the player based on the amount of play.

U.S. application Ser. No. 2006/0080613 describes a method for establishing personal profiles for members of a virtual community, rating each participant according to that participant's activity levels within the virtual community, having the participant recommend new participants to the community and enabling the first participant to send a gift to the second, new, participant.

U.S. Application No. 2006/0205483 describes a system for wagering in which participants may wager against each other in a contest. At the beginning of the contest, the participation fees collected from each participant may be pooled for distribution of at least a portion thereof, as a prize pool, to selected bettors based on the more favorable outcomes of their wagers. The system described may operate in a fantasy game or a real gaming context.

U.S. Application No. 2006/0247035 describes a method for monitoring usage of gaming machines and awarding bonuses to the users of these machines. The system incorporates a wide area bonus method in which a central computer server accumulated usage data from a bank of gaming machines located in a facility.

Application No. 2001/0034647 describes an online banner advertising program which registers users of a data network, in which the users have an opportunity to engage in a selected activity, in a benefits program that offers a random incentive while keeping each user's identity anonymous. The user can then designate a beneficiary to receive the incentive.

U.S. Application No. 2005/0159998 describes a method for rating members of a social network in which users of the social network are provided with an electronic ratings interface, which is then used to rate a member of the social network's personality. Multiple user ratings for the member are then associated with the member and an overall rating is computed for the member based on a weighting factor that is proportional to a user rating, and generating icons that can be used to distinguish between groups of members with particular ratings.

U.S. Application 2007/0198510 claims a method for assigning ranking scores to internet users of a networking site and a content site, in which the users of the networking site become associated as friends, and the content site enables each user to rate content published on that site by other users. In this respect, users of the networking site are assigned a network popularity rating based on the number of friends associated with each user. Content published by the rated user on the content site is also assigned a content popularity rating. Both ratings are then used to determine customer influence ranking scores based on the content popularity rating, to the user. The ranking scores are then provided to third parties, such as sellers of goods and services for the purpose of offering discounts to the users with most favorable customer influence ranking scores.

U.S. Application 2007/0093298 claims a method for group play of an online lottery game in which players are each allowed to create an online personal profile by submitting personal payment means information, i.e. a credit card number, and to become part of an online group by linking to each other's personal profiles. The online group can then purchase at least one lottery ticket as a group. The method described allows group purchases without the need for a group leader to keep records or purchase tickets.

It is noted that in 2006, the United States Congress passed into law the Unlawful Internet Gambling Enforcement Act of 2006 (UIGEA). This statute prohibits bets or wagers that facilitate gambling across state lines and also prohibits the transfer of funds from a financial institution to Internet gambling sites. However, some gambling-related activities are excluded from the prohibition, such as fantasy or simulation sports games, educational contests, online lotteries and contests that comply with laws in the state in which they are conducted, and other exclusions controlled by federal statutes, such as horse or harness racing.

### SUMMARY

The invention essentially comprises a transaction system and method for conducting transactions using the Internet, comprising forming a business entity comprised of operating members and general members, wherein individuals are appointed as general members based on their subscription to the business entity; and further wherein each general member becomes eligible to qualify for a share pool; creating an Internet web site for use by members and other persons who wish to complete one or more transactions; facilitating the advertising and completion of one or more transactions offered by any members to the other members of the business entity using the site; wherein a process of selection is applied for each member who offers or solicits offers for a transaction, comprising retaining a portion of the revenue from each transaction conducted during a certain period or for a selected group of transactions to create the share pool; and awarding the share pool to the participating member or members having the highest scores during that period or for that selected group of transactions. In a particular embodiment of the invention, the process of selection comprises, for each general member who offers or solicits a transaction, such as the sale of goods and services, assigning a weight value to the member offering or soliciting offers for the transaction; using one or more calculations to assign a weight to the member offering or soliciting offers for each transaction; using one or more calculations to assign a weight value to each general member who is the end user or purchaser for each transaction; computing a total weight value for each general member; determining a selected range of total weight values achieved by participating members for that selected type of transaction or group of transactions; and selecting one or more members having a total weight value within the selected range of values to be awarded the share pool.

According to various embodiments, the invention may be applicable in the fields of internet sales of various commodities and services, for example digital products such as audio, video, music files and e-books; as well as in industries where random selection of persons is used to award prizes or incentives from among a larger group of participants. Examples of these include activities in promotional context such as a sweepstakes or rewards program, or in a gaming context such as a lottery, or horse or harness racing. The invention is thus capable of legal means, and may also be applied in altruistic approaches, such as for charitable fundraising.

### BRIEF DESCRIPTION OF THE DRAWINGS

FIG. 1 Is a schematic diagram showing how the transaction system is configured according to the elements described herein.

FIG. 2 is a flow diagram exemplifying configurations of the application software used to calculate share pools according to the method of the invention.

FIG. 3 is a flow diagram showing an embodiment of the invention, in particular wherein a share pool is calculated and disseminated based on a type of sales transaction conducted by general members of the social network business entity.

FIG. 4 depicts another embodiment of the invention including the process of a typical sale transaction in which a good or service offered for sale by a member of the business entity is managed according to the transaction system described herein.

### DETAILED DESCRIPTION OF PREFERRED EMBODIMENTS OF THE INVENTION

This invention arises from a new business model that serves social networking sites and its users. It creates a process that combines, as elements, social networking, share pools generated from tiered random selection of incentives, and a business entity, preferably a limited liability company formed according to state law, to create a profit sharing structure. This profit-sharing structure in turn incentivizes participation by users of the social network, and the resulting effect is more effective monetization of transactions conducted using social media. For example, applications of the invention could reduce digital media piracy, while increasing revenues to creators of digital media content who upload and make such content available through the internet.

The method of the invention thus changes the way social networking functions on the internet by essentially creating a social networking business entity with an unlimited number of members as partners in the enterprise. The business entity, which in a preferred embodiment may be a limited liability company (LLC), converts each new subscriber to the social network into a member partner, upon the subscriber's payment of a partnership fee and assent to the LLC's operating agreement. The process in this way creates a company structure that is both business and customer base in one, in that the business entity facilitates transactions between members of the social network and other members, or other users such as free subscribers, while the members and users also form the base of customers to whom transactions are offered. The incentive to participate is created when a percentage of the proceeds generated from the social network's activity is put into share pools, which are then awarded to members of the LLC who have been selected by a method as described elsewhere in this application. This method determines members eligible to receive the share pool based on participation, i.e. where higher participation increases the probability of being awarded the pool.

The method by which an incentive is awarded is determined, in one example, by a set of algorithms that gives a weight to particular activities on the site and assigns that weight to a member when they endeavor in that activity, which act like points. When the share pools are disseminated an application uses the weights accumulated by members to define the probabilities under which the pools are to be awarded. It is not the social network, the form of the business entity or the profit sharing pool, each taken alone, that is the innovation; rather it is the use in combination of all three; along with the method by which the share pools are awarded, that results in the creation of a business structure that incentivizes buying and selling and extends the profit motive to all social network members.

The implementation of this model is achieved by setting up a social network as a business entity, such as an LLC, and creating an operating agreement that defines the terms under which the business operates. The terms define the member-owned nature of the business entity, and any distinction that separates those members. In one embodiment of the invention, the social network provides the user interface of a business entity having two types of members. Managing members are those members who originally conceived, created or invested in the business entity at the time of its organization in a state of operation, and who are responsible for administrative, governing and financial oversight of the organization. General members are members who join the business entity by subscribing to the social network, and who are issued one or more general shares of the business entity upon payment of a subscription fee. Managing members and general members may access and use the social network, including for offering and participating in transactions presented to other members and to users from the general public who are not members, but who may subscribe to the social network without electing to become a member of the business entity or to pay a subscription fee.

It is to be understood that another business entity instead of an LLC, in which member shares may be determined solely according to the terms of the governing agreement may also be selected. For example, the business entity may be a low-profit limited liability company (L3C) if the intended purpose of the social network is to facilitate some philanthropic benefit for a charitable, educational or social purpose while at the same time providing for the accumulation of profit by investors.

Participating members are those members who participate in the social network's activities and transactions online. In this respect, managing members and general members may be participating members. However, managing members are not eligible to receive share pool awards, for which eligibility is limited to general members. Managing members may however receive whatever proceeds remain after the contributions to the share pool, determined as a percentage from a transaction, have been deducted. The percentage of the proceeds allotted to the incentive awards may vary and is defined by managing members according to the process of this invention. The amount is, desirably, sufficiently beneficial to participating members to qualify as an adequate incentive for participating in the social network's activities. The methods of determining and selecting recipients of the share pool awards are fully disclosed in the terms and conditions of membership, also known as the operating agreement, to applicants who request to become members of the business entity. An applicant is an individual who indicates, at the time of subscription to the social network's web site or at any time thereafter, a desire to become a paid subscriber, i.e. a member of the social network. The applicant is required to agree to the aforementioned terms and conditions in order to be eligible a member of the social network LLC. Managing members and general members are required to agree to the operating terms and conditions.

The subscription process may be accomplished through methods conventionally employed to enlist members in social networks, or any combination thereof. Subscribers may be solicited through conventional means, such as print or electronic advertising or multimedia promotions. A significant difference from the typical subscription process, however, is that visitors to the social network web site have the option of signing up for free membership or a paid membership, which upon acceptance of the operating agreement, allows the subscriber to become a general member of the business entity that operates the social network. Free membership allows use of the social network for linking to other users, uploading and sharing a personal profile, and availing of the services offered by the social network, whether those be the sale of goods or services or participation in a contest. Subscribers to the free format are thus considered users and not members, and such users are not eligible to be awarded a share pool incentive.

Upon payment of a subscription fee and acceptance of the site policy as well as to terms of the operating agreement, the subscriber becomes a general member of the business entity. Communication of the essential terms and conditions of the operating agreement may be made in video format, and the video posted on the social network site's application page. Upon indicating agreement to the operating agreement, a prospective member is then prompted to pay a subscription fee, also referred to as a partnership fee. This fee is valid for a certain time period, depending on the amount of the partnership fee paid; for example the prospective member may elect to subscribe for a period of months, a year or multiple years. General member status in the business entity is confirmed upon payment of the partnership fee.

General members are encouraged to participate in various social networking activities where the members participating in such activities are assigned weight values. These activities include, but are not limited to, buying selling, and advertising goods, services, games and contests. The weight values are accumulated in the member's profile each time the member engages in the activity. Positive or negative weight values may be applied, depending on the activity, and these are then later used to determine the probabilities under which the share pools are to be awarded. Weight values are determined based on a particular activity's economic relevance to the well being, prominence or effectiveness of the social network. For example, using a weighting system of −100 to 100 (where 100 is the highest) chatting and commenting might be both given values of 1 while buying would for example be given a value of 99 and selling a value of 79. Posting a link to an outside site, or posting illegal or offensive material would be assigned a negative value. Values may vary and are posted and fully disclosed to all members.

The rational for using this probability-based system as opposed to a simple points-based one is to ensure that members with the most financial resources cannot simply purchase a large accumulation of points, and thus be awarded the share pool, while reducing the likelihood that a member who uses the network less because of limited resources is effectively prevented from winning the share pool award.

A probability-based system can be given more objective parameter constraints, for example to increase the chances to win for members who have not yet previously won a share pool, relative to those who have; and the system can be tailored to allow for numerous forms of participation, some of which may be non-economic, although economic transactions, i.e. the exchange of value, is the main one. By incorporating multiple factors as criteria for determining weight values, and thus the share pool, the probabilities can be maximized to allow all general members the best possible chance to win a share pool. It should be noted though, that because economic participation activities are given heavier weight values, the odds would still to some degree favor those with the most financial resources. This is a fact of life and reflective of the commercial world; however an advantage of using the system of this invention is there would be no guarantee of a win to the participating member with the most resources, and this would therefore would discourage manipulation of the system.

The share pool which forms the incentive for participation in the social network's activities may be funded by retaining a share of the subscription fee paid by enrolling users to become general members of the business entity. The subscription fee is not a one-time fee, and may be assessed at intervals predetermined by the management of the business entity, for example quarterly. The share pools may also be funded by taking a percentage of the gross sale value of a good or service being offered for sale by a member of the social network to general members or other users of the social network. This percentage (e.g. 15%) is put into the share pool to be later awarded. In this respect, every time revenue is generated from the social network through means including but not limited to advertising, digital media, or subscriptions, a percentage goes into a share pool. For example, in a media purchase transaction, when a member user buys a song that cost 1.00 dollar, 75 cents goes to the artist member and 25 cents goes to the social network LLC. Out of that 25 cents retained by the social network LLC, 15 cents would go into a share pool. Conversely, when a member sells something for 1.00 dollar, a commission of 25 cents is generated and goes to the social network LLC, and a percentage of this commission will go into a share pool. The percentage contributions to the share pool may vary according to schedules operated by the social network, however this information is posted and subject to disclosure to all members. The share pools that can be formed according to this process are not limited to any discrete number, however they may be capped at a certain total pool amount, for example 5000 dollars. Once the cap is reached, a new share pool may be started. In this manner, increased site membership enrollment and ensuing activity will result in the development of more share pools.

Weight values may be determined by several alternative means. For example, in one embodiment, the managing members of the limited liability company may assign an initial weight value to an activity conducted by users of the social network. For example, a participating member who uploads an original song as an audio file and offers it for sale on the social network's site is assigned a weight value for the upload. Each general member who buys the audio file as a download is also assigned a weight value for the purchase. If the user is not a general member and belongs to the site as a free subscriber, then no weight value is assigned for the purchase, and that user is not eligible to win any share pool. Alternatively, in another embodiment, in addition to weight values being assigned by managing members, general members may also provide input, feedback and suggestions to the managing members about increasing or decreasing the weight value for a particular activity. The weight values may then be tallied for each member, and the winner of the share pool is selected from the members within a certain range of weight values that has been identified for selection of that share pool.

In another embodiment, a series of computer operations may be applied to calculate the weight value for each activity. In this respect, one or more rationally designed algorithms may perform the functions of assigning values to identified activities, computing the weight values, and tallying the weight values for members and users, defining the range of weight values eligible for a share pool award, and selecting the winner or winners of the share pool.

Share pools are capped at certain amounts, and are funded by particular revenue streams, example some may be capped at 5000 dollars and funded by digital media revenue, to as high as 250,000 dollars that are funded by subscription revenue. Once the maximum for the share pool is reached, another pool is started; this means that there can be many pools at varying amounts being built at the same time. This is to increase the overall amount of pools and vary their sizes to be able to award and incentives more members. The pools can be, but not limited to, being awarded at varying time intervals, for example 5000 dollar pools may be awarded on a weekly basis, and 250,000 dollar pools could be awarded on a quarterly basis.

A software application component is included as an aspect of this invention for the purpose of properly disseminating the share pools. As previously mentioned it uses a system of probabilities to determine how share pools are awarded. Using classical and, as may be required quantum algorithms, the application scours the site and determines the status of each member as a potential awardee. Members accumulate weight values each time they engage in site activities, and different activities carry different weight values, as do events. Events are defined as circumstances that the application considers to affect the probable outcome, for example the size, time interval or previous award of the share pool. The application then uses the values accumulated by all the members to define the probability of receiving the award. It does this by narrowing its choice to those members within a range of the highest total weight values and then choosing randomly. The weight values may act like points, but the application does not use a points system. It differs in that just because a member might have the most values/points, the member is not necessarily automatically eligible to receive the share pool proceeds. These weight values only increase the chance; and if the member has already been awarded for example, they can decrease it. Although the more people involved the lower the probability of being awarded a share pool, is a resulting aspect of this system, it is offset by the amount of share pools that are created when more people participate. To ensure against manipulation, once a member is awarded a reverse check is performed by the application to verify how it arrived to that member confirming the member actually did participate.

By giving different weight values for the activity and to the amount spent, the playing field can be leveled to give all participants a chance at the share pools. The weight values and ranges may vary and are adjusted accordingly to maintain equilibrium between profitability, and the dissemination of share pools.

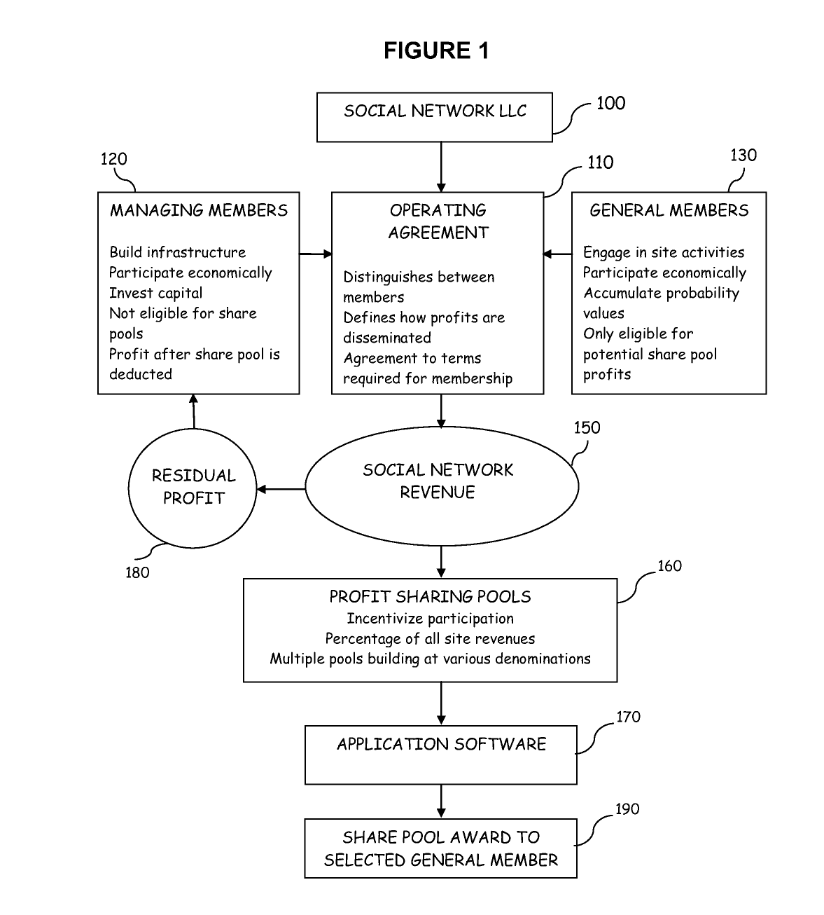

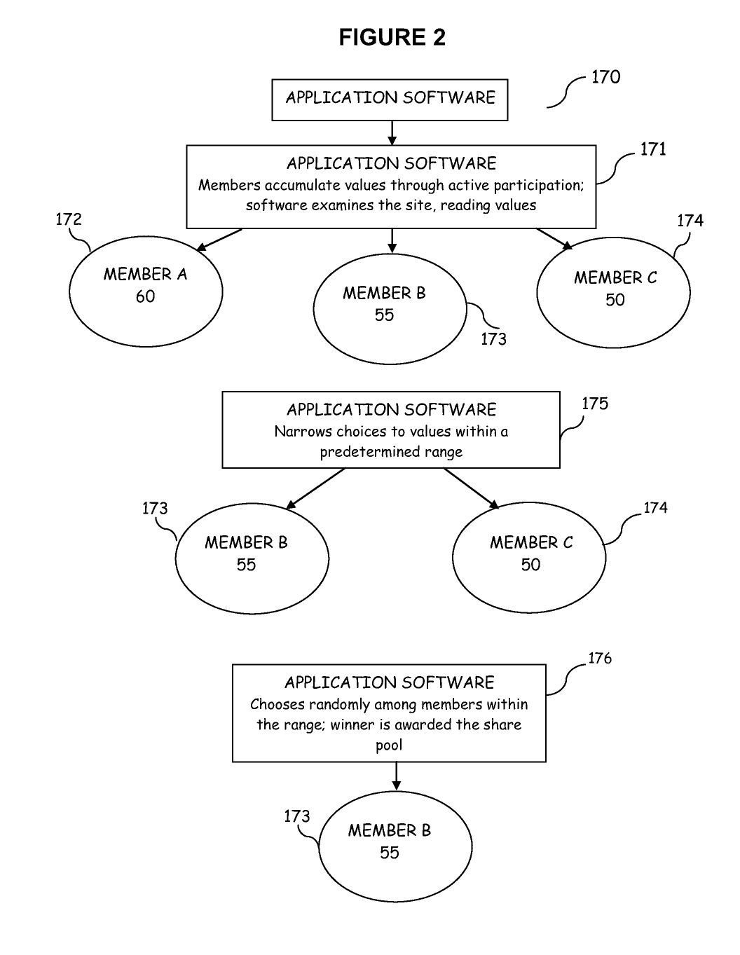

FIG. 1 presents an overview of one representative embodiment of the invention, in which a social network LLC 100 is formed, its membership comprised of managing members 120 and general members 130. Membership is established when the members enter into the operating agreement 110. It is to be understood that the LLC may continually add new members over time, and members may also withdraw, in which event withdrawal will be managed by procedures set out in the operating agreement 110. The maximum number of members to be added is infinite, and may be limited only by applicable provisions of the laws governing limited liability companies in the state where the LLC is established. As transactions are conducted between members via the social network, revenue 150 is generated, and a portion of the revenue generated is used to form profit sharing pools 160. The residual profit 180 after the share pool contribution is deducted is distributed between the managing members of the LLC. The amounts set aside for the profit sharing pools 150 are subjected to application software 170, which determines other aspects of distribution of the share pools, as is shown in FIG. 2, which is discussed below. The share pool is then awarded to a selected general member or members, as shown by element 190.

According to FIG. 2, the application software 170 may be configured to perform multiple processes. In a first configuration, the application software 171, searches for weight value criteria, and computes and assigns weight values for all members 172, 173 and 174 who are actively engaged in a particular type of transaction across the social network. In another configuration of the application software 175, computations are applied to narrow the choices for winners of the share pool to values within a predetermined range. As a result, according to the example in FIG. 2, members 173 and 174 have assigned values that fall within the predetermined range, while member 172 is eliminated. In a further configuration of the application software 176, an intelligent random selection is made from the members with values within the predetermined range to choose member 173 as the winner of a share pool.

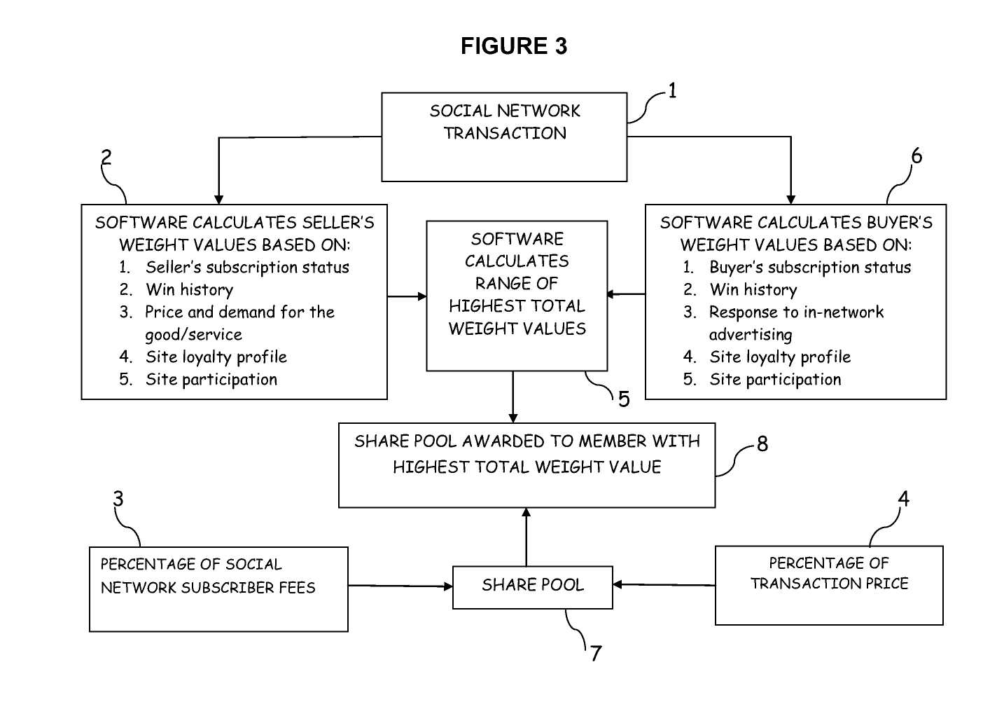

In the embodiment according to FIG. 3, a social network transaction 1, which can be either the sale of a product (a good or service), or a game, is subjected to computational treatments 2 and 6 to determine total weight scores for the general member who is the seller or offeror, and other general members who are the buyers or players. Predetermined factors are input to allow for calculation of a total weight value 2 to be assigned to the seller, for example based on the price of the product or game being offered; market demand; the seller's win history (since previous wins within a pre-determined time period are factored as a negative weight value to promote the generation of new winners); the seller member's subscription status, for example length of membership and dues payment status; site participation; and the seller's loyalty profile, which could include compliance with criteria such as whether the seller makes the product available via other unrelated web sites and provides links to those sites on the seller's social network profile page. Similarly, a total weight value 6 for the buyer might be cumulatively determined based on factors such as the buyer's subscription status; win history; response to in-network advertising; site participation and site loyalty profile. As reflected in FIG. 3, a range of total weight values 5 encompassing the highest total weight value scores for all participating members is then determined, and according to box 8 of the flow diagram, one or more winners selected from this range of eligible participating members to receive the share pool 7.

Although they both employ elements of chance, this system is not to be misconstrued with a lottery in its conventional form, because members actively increase their chances of being awarded a share pool through participation, plus there exists a value benefit for an actual and separate item being consumed (e.g. downloads of digital media), as opposed to just paying for a “shot at a pot”. Another difference is that the process of the invention provides a business entity structure which, through the consent of its members, is choosing the method by which to disseminate profits earned; that structure and the application to social network online communities is the innovation.

### EXAMPLES

### Example 1

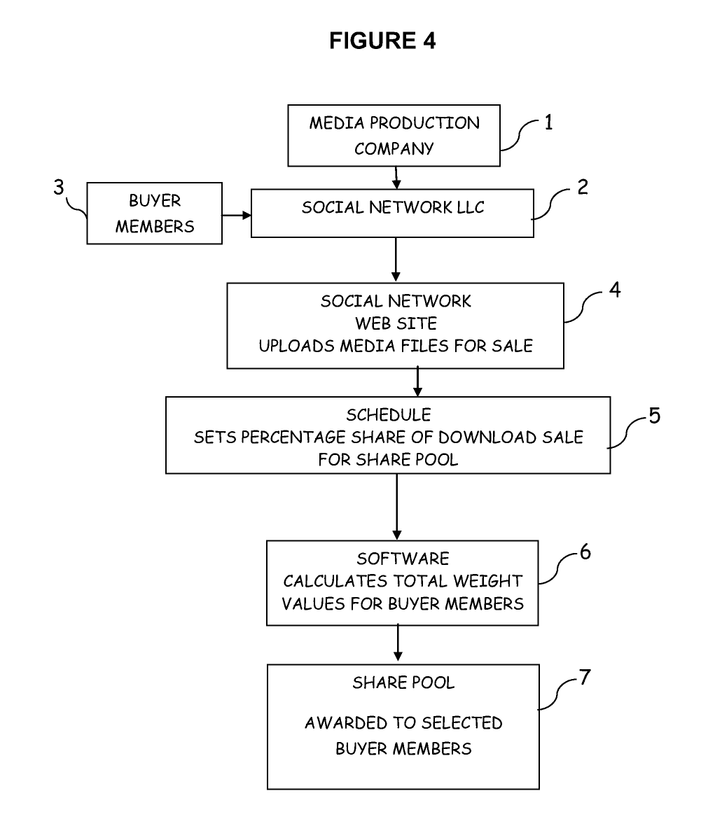

According to one embodiment of the invention, as shown in FIG. 4, a media production company 1 joins a social network LLC 2 and buys a subscription, thus becoming a general member of the LLC. Users who are potential customers of the media company's products also become general members of the social network LLC as buyer members 3. Media production company 4, exercising its privilege as a general member, uploads original or other authorized music, audio or video files to the social network's web site, and the uploaded material is linked to the member profile established for media production company 1. Managing members (not shown) of the social network LLC 2 use a pre-determined schedule 5 to determine the percentage of each sale or download of the products offered for sale by media production company 1 that should be retained to contribute to a share pool 7, which will form the incentive prize for buyer members 3 who download the products. (It should be noted this means of assembling a share pool and determining winners is but one of several alternatives discussed herein with respect to other embodiments of the invention.) Each buyer member 3 accumulates values for participation and purchases of a particular product. Weighted values are assigned to the media company's and the customers' respective participations by a software application 6 that calculates weighted values based on several factors. For buyer members 3, weight value factors applied include each buyer member's frequency and extent of use of the network, and the buyer member's purchasing profile. Based on the values accumulated, the software application 6 also selects a range of values encompassing the highest weight values for all buyer members 3 who purchase the product. From this range of weight values, one or more of the buyer members 3 is chosen as the awardee of share pools.

In another variation of the process according to this example, which is not depicted in FIG. 4, the media company 1 could also compete for the share pool. In this respect, weight values are computed based on factors including but not limited to the popularity of the files offered for sale, price and the media company's frequency of use of the social network, The resulting weight values are then included in the range of highest selected values to determine the winner of the share pool.

### Example 2

This example demonstrates calculation of the weight values used to select winners of a share pool. The method uses a weight value scale of −100 to 100, with 100 being the highest possible value. Member A buys a song at 1.00 dollars, and the purchase is given an activity weight value of 55, and a price weight value of 5 (factoring in the amount spent). Member B buys a video download at 3.00 dollars, and this purchase carries an activity weight value of 50 and price weight value of 5. Member C buys advertising on the site at 100.00 dollars, which has an activity weight value of 45 and a price weight value of 30, however C was previously awarded a share pool, and this previous win is assigned a negative value that is dependent on the situation (size of pool received, how long ago, etc), for example −25. The software application used to select a potential range of winners based on these values will determine a weight value of 60 for member A, 55 for member B, and 50 for member C; then from the values falling within a predetermined range it will choose randomly who will receive the award. In this example, when the range is between 45 and 75, member B is chosen as the winner of the share pool.

In a simple points system, member A with 60 points would automatically be the prospective winner, however, by using probabilities member C, even though having already been previously awarded a pool is still eligible to become a winner, thereby incentivizing C's continued participation.

Values are used to encourage or deter certain site behavior, like for instance; posting unauthorized links to outside sites can result in a negative value. Member's pick up values for frequency of use, loyalty, and referrals; and virtually every activity is given a value. An example of how weight values are adjusted to achieve equilibrium in the dissemination of profits is to compare the situations between member A and member C from the above example. Member A buys a song download for 1.00 dollar, and receives a weight value of 55 and price weight value of 5, member C buys advertising for 100.00 dollars and receives a weight value of only 45, but receives a price weight value of 30. The seeming discrepancy between the values of buying songs and ads is because most of the members on the social network will likely be spending low amounts of money on items such as digital media, while larger amounts are likely to be spent by businesses buying ads. If buying ads, because it costs more, were to receive a heavier weight value than buying songs, this would result in an overwhelming gap between the average member who buys digital media downloads, for example, and advertisers or businesses; which would result in the accumulation of more values by the latter, thereby always increasing the probabilities in their favor.

The invention claimed is described in this specification with reference to certain exemplary embodiments. However, it will be evident that various modifications and changes may be made to the various embodiments described herein without departing from the broadest scope and spirit of the invention. Accordingly, this specification and drawings are to be viewed as illustrative of specific embodiments of the invention and not restrictive or otherwise limiting of the scope that is set forth in the accompanying claims.

What is claimed is:

1. A method for conducting transactions to provide a profit-sharing incentive for users of a social network using the Internet, comprising:
a. Forming a business entity comprised of managing members and general members, wherein the business entity facilitates the conduct of revenue-generating transactions online; and wherein individuals are appointed as general members based on their subscription to the business entity and payment of a fee; and further wherein each such general member becomes eligible to qualify for a share pool based on activities facilitated by the business entity;
b. Creating an internet site for use by the business entity, its members and other users who wish to complete one or more transactions;
c. Facilitating the completion of a selected group of transactions between a general member of the business entity and the group selected from other general members and other users via the internet; wherein for each general member who offers or solicits offers for a transaction, or who is the end user or purchaser in a transaction within a group of transactions, a process is applied comprising:
i. Using one or more calculations to assign a weight value to the general member offering or soliciting offers for each transaction;
ii. Using one or more calculations to assign a weight value to each general member who is the end user or purchaser for each transaction;
iii. Computing a total weight value for each general member; and
iv. Determining a selected range of the total weight values assigned to the general members;
d. Retaining a portion of the net revenue from member participation in the business entity to create a share pool;
e. selecting one or more general members from within the selected range of total weight values as a winner; and
f. Awarding the share pool for that selected group of transactions to the winner.

2. The method of claim 1 wherein the calculation to assign a weight value is performed using a computer application.

3. The method of claim 1 wherein the transaction is the sale of goods or services.

4. The method of claim 1 wherein the transaction is a contest.

5. The method of claim 1 wherein the transaction is a game, fantasy sport, or horse or harness racing contest conducted in compliance with federal and state laws.

6. The method of claim 1 wherein the portion of net revenue retained to create the share pool is obtained from a share of the subscription fee paid by each general member, a share of the net profit from each transaction, or a combination thereof.

7. The method of claim 1 wherein the business entity is a limited liability company formed according to state law.

8. The method of claim 7 wherein the general members and managing members function subject to a mutually agreed operating agreement.

9. The method of claim 8 wherein the general members become limited partners.

10. The method of claim 1 wherein the internet site is a social networking site.

11. The method of claim 10 wherein the internet site sells goods and services.

12. The method of claim 11 wherein the internet site sells goods and services to users who are not members of the business entity.

13. The method of claim 10 wherein the internet site sells electronic media downloads.

14. The method of claim 14 wherein the internet site sells music, audio and video downloads.

15. The method of claim 12 wherein the internet site sells e-book downloads.

16. The method of claim 12 wherein the internet site sells subscriptions to interactive online video games.

17. The method of claim 1 wherein each of assigning of the weight value, computing the total weight value and selecting the general members with the highest total value is accomplished by application of one or more algorithms.

18. A method for creating a profit-sharing incentive for members of a business entity who are commonly enrolled as subscribed users in an online social network, and who conduct transactions as participating members of the business entity via the internet, comprising, for a selected group of transactions:
a. Using one or more calculations to assign a weight value to the general member offering or soliciting offers for each transaction;
b. Using one or more calculations to assign a weight value to each general member who is the end user or purchaser for each transaction;
c. Computing a total weight value for each general member; and
d. Determining a selected range of total weight values;
e. Retaining a portion of the revenue from each transaction within the selected group of transactions to create a share pool; and
f. Awarding the share pool to one or more general members having an assigned weight value within the selected range of total weight values.

19. The method of claim 18 wherein the business entity is a limited liability company organized according to state law.

20. The method of claim 18 wherein each of assigning of the weight value, computing the total weight value and selecting the one or more members having an assigned weight value within the selected range of total weight values is accomplished by application of one or more algorithms.
